(19) United States
(12) Patent Application Publication
(10) Pub. No.: US 2026/0149183 A1
(43) Pub. Date: May 28, 2026

(54) SPACE TIME CHAOTIC ANTENNA ARRAY ACTIVE INCOHERENT MM-WAVE IMAGING SYSTEM

(71) Applicant: UNIVERSITY OF SOUTH FLORIDA, Tampa, FL (US)

(72) Inventors: Stavros VAKALIS, Tampa, FL (US); Gokhan MUMCU, Tampa, FL (US)

(21) Appl. No.: 19/400,968

(22) Filed: Nov. 25, 2025

Related U.S. Application Data
(60) Provisional application No. 63/724,635, filed on Nov. 25, 2024.

(51) Int. Cl. H01Q 13/08; H01Q 13/10; H01Q 21/29; H01Q 25/00

(52) U.S. Cl. CPC H01Q 13/085; H01Q 13/10; H01Q 21/29; H01Q 25/001

(57) ABSTRACT

An apparatus comprising an antenna array including multiple planar slot antenna elements with integrated feedlines, wherein the positions, orientation angles, and feedline lengths of the antenna elements are mutually uncorrelated to produce spatial and temporal incoherence. The apparatus may include a substrate having irregular ridge faces supporting the antenna elements, a switching circuit configured to activate subsets of the antenna elements according to randomized or pseudo-random sequences, and a controller operatively coupled to the switching circuit.

### CROSS-REFERENCE TO RELATED APPLICATIONS

This application claims priority to U.S. Provisional Patent Application Ser. No. 63/724,635, filed on Nov. 25, 2024, the entire disclosure of which is incorporated herein by reference.

### BACKGROUND

Interferometric imaging systems utilize spatial correlation of electromagnetic fields to reconstruct scene information with high resolution. Such systems typically rely on the Van Cittert-Zernike theorem, which relates the spatial coherence of a radiating aperture to the Fourier transform of its intensity distribution. Conventional implementations employ large, fully populated phased arrays or mechanically scanned apertures to synthesize the required baseline diversity. These architectures often incorporate phase-controlled feed networks and precise element positioning to maintain deterministic beam patterns, resulting in significant hardware complexity, high cost, and stringent calibration requirements. Prior approaches to active millimeter-wave imaging have generally adopted coherent illumination strategies, wherein transmit arrays generate phase-aligned signals to enable beamforming and range resolution.

### BRIEF DESCRIPTION OF THE DRAWINGS

FIGS. 1A-1B illustrates an antenna array configured as a chaotic antenna array (CAA) for millimeter-wave (mm-wave) imaging applications.

FIG. 2 illustrate an example mm-wave imaging system.

FIG. 3 illustrate an example imaging processing architecture.

FIG. 4 illustrates a flowchart of an example method for interferometric imaging.

FIG. 5 illustrates certain components that may be included within a control system, which may be configured to manage operations associated with embodiments of the present disclosure, such as the features discussed with reference to FIGS. 1-4.

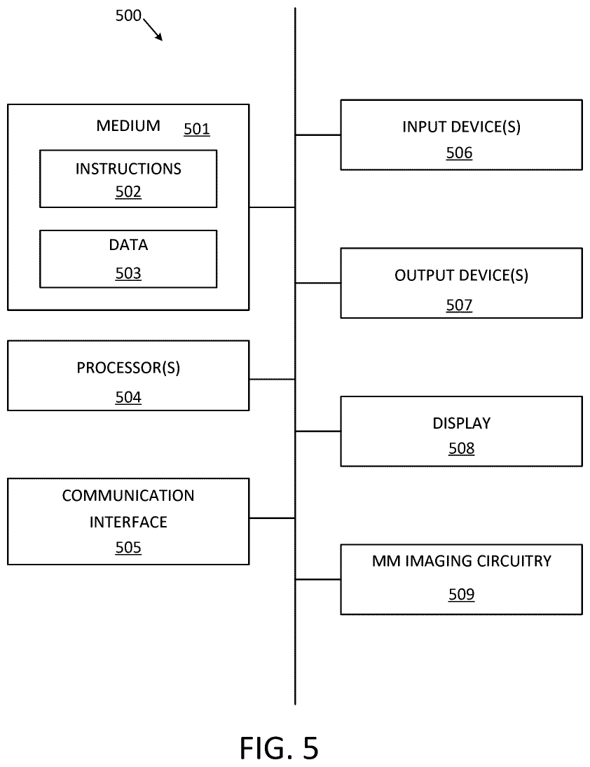

### DETAILED DESCRIPTION

Conventional millimeter-wave imaging systems have historically relied on fully populated phased antenna arrays configured to generate spatially coherent illumination across the aperture. These architectures typically employ deterministic element placement and phase-controlled feed networks to synthesize directive beams, which necessitates precise calibration and complex control circuitry. Such systems often require large apertures to achieve adequate angular resolution, resulting in increased cost, weight, and fabrication complexity. Furthermore, the reliance on coherent transmission introduces stringent requirements for oscillator stability and phase synchronization, which complicates hardware design and limits scalability. In addition, conventional beamforming techniques exhibit susceptibility to grating lobes and spatial aliasing when aperture sparsity is introduced, thereby constraining opportunities for cost reduction through element reduction. Attempts to mitigate these limitations using compressive sensing or synthetic aperture methods have demonstrated partial success but remain computationally intensive and sensitive to residual coherence artifacts. Accordingly, prior approaches have struggled to balance resolution, cost, and operational robustness in real-time imaging scenarios.

The present disclosure addresses these deficiencies by introducing a chaotic antenna array architecture configured to produce spatially and temporally incoherent illumination without reliance on active phase control. In some embodiments, the system comprises radiating elements disposed on non-planar, randomly angled facets with uncorrelated feedline lengths and positions, wherein structural randomness and dynamic switching collectively generate noise-like transmission signals. This configuration satisfies interferometric imaging requirements by reducing mutual coherence across the aperture, thereby enabling high-resolution image reconstruction using substantially smaller and sparser arrays. Additionally, the incorporation of randomized activation patterns and polarization diversity enhances entropy in the illumination field distribution.

Before any examples of the disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use examples of the disclosure. Various modifications to the illustrated examples will be readily apparent to those skilled in the art, and generic principles presented herein can be applied to other examples and applications without departing from examples of the disclosure. Thus, examples of the disclosure are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosure. Skilled artisans will recognize the examples provided herein have many useful alternatives and fall within the scope of examples of the disclosure.

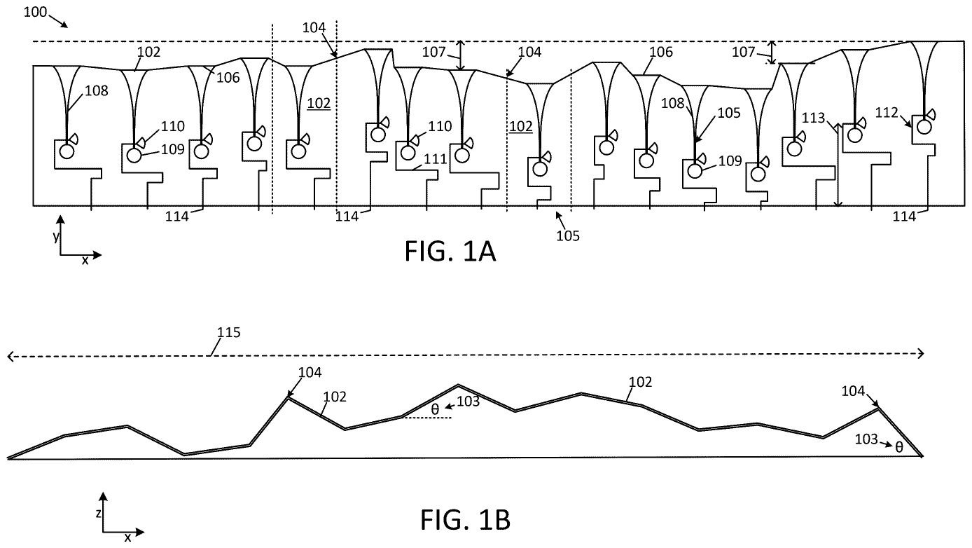

FIG. 1 illustrates an antenna array 100 configured as a chaotic antenna array (CAA) for millimeter-wave (mm-wave) imaging applications. In some embodiments, the antenna array 100 comprises a plurality of radiating elements disposed upon a substrate 101 in a spatially non-uniform arrangement, wherein the positional randomness of the elements and variability in associated feed paths collectively produce electromagnetic fields that are uncorrelated in both spatial and temporal domains. Such incoherent illumination satisfies interferometric imaging requirements by reducing signal correlation across the aperture, thereby enabling image formation using an aperture dimension substantially smaller than that of conventional filled arrays. The substrate 101 may be fabricated using additive manufacturing processes, such as three-dimensional (3D) printing, which permits integration of conductive and dielectric features while maintaining inherent variability that characterizes the chaotic configuration. Although FIG. 1 depicts a one-dimensional arrangement of radiating elements, other embodiments may employ any suitable configuration, including but not limited to two-dimensional planar arrays, three-dimensional volumetric arrays, conformal arrays disposed on curved or faceted surfaces, or hybrid arrangements combining multiple orientations and polarization states.

Referring now to FIG. 1, an antenna array 100 is disposed on a substrate 101 comprising a plurality of planar facets 102, each facet being defined by a facet angle 103 and joined at facet junctions 104. In some embodiments, the substrate 101 is fabricated using additive manufacturing techniques such as laser-enhanced direct print additive manufacturing (LE-DPAM). In various examples, the substrate 101 may further include any of various additional circuitry, or structures, such as ground planes, interconnect circuitry, switching circuitry, structural support layers, etc.

In some embodiments, a substrate 101 may comprise a plurality of planar facets 102 upon which antenna elements are disposed. These facets can include, but are not limited to, ridges, pyramidal structures, or stacked configurations that provide multiple faces for antenna placement, thereby increasing the available surface area for element distribution. The non-planar configuration of substrate 101 introduces structural variations that facilitate polarization diversity and spatial incoherence across the antenna array 100. For example, as illustrated in FIG. 1B, each facet may be a different height, e.g., each facet may have some displacement (in the nominal z direction) from principal axis 115. As another example, each facet 102 may have a facet angle 103. In the illustrated example, facet angles 103 are angles about the y axis (e.g., the z-height of the facet is constant along the nominal y axis). In further examples, the facet angles 103 may have additional components, such as slope along the y axis and x axis.

The facet angles 103 may be randomized within the specified range to introduce geometric diversity across substrate 101, thereby contributing to incoherent illumination patterns when the antenna array 100 is energized. Randomization may follow a uniform distribution to maximize entropy, although other suitable distributions may be employed depending on design objectives. In certain examples, the facets 102 are formed with slope variations selected from a range of approximately ±45° relative to a reference plane, which accommodates nozzle clearance requirements during additive manufacturing processes such as three-dimensional (3D) printing. For instance, in this example, each angle may be determined in a uniform random distribution between +45° and −45° (or other slope constraints according to the manufacturing process, such as preventing collisions between printing tips and previously deposited material layers during non-planar printing operations). In some examples, the facet angles 103 may be selected such that each facet exhibits a unique inclination, and any suitable angle within the manufacturing tolerance—such as approximately 45°±—may be employed.

In some embodiments, each facet 102 may support one or more Vivaldi antenna elements 105 comprising an exponential tapered slot 108 and an associated feed line 111. The feed line 111 may terminate in a radial stub 110, which in certain examples may approximate a quarter-wavelength electrical length to provide impedance matching across a broad frequency range. Additionally, the feed line 111 may include a circular aperture termination 109 disposed adjacent to the tapered slot 108 to facilitate broadband coupling between the feed structure and the radiating aperture. The antenna aperture 106 formed by the tapered slot 108 may extend along the facet 102, while the feed line length 112 and feed line distance 113 may be configured to maintain impedance continuity under randomized geometric conditions. In some implementations, conductive portions of the Vivaldi antenna element 105 and feed line 111 may be fabricated from metallic layers such as copper, while the substrate 101 may comprise low-loss dielectric materials suitable for millimeter-wave operation. Although FIG. 1 illustrates a linear arrangement of Vivaldi antenna elements 105, other embodiments may employ non-linear or faceted configurations wherein each facet 102 hosts a distinct antenna aperture 106 with similar or varied slot geometries.

The physical dimensions of the tapered slot 108 and feed line 111 may be selected from ranges that accommodate millimeter-wave operation while permitting structural variability to enforce spatial incoherence. For example, the aperture width of the tapered slot 108 may be selected from a range of approximately 5 mm to 10 mm, such as a range of 6 mm to 8 mm (e.g., 6.75 mm); the slot length may be selected from a range of approximately 15 mm to 25 mm, such as a range of 18 mm to 20 mm (e.g., 19 mm); the overall element width may be selected from a range of approximately 10 mm to 18 mm, such as 12 mm to 14 mm (e.g., 13 mm); and the overall element length, including feed extension, may be selected from a broad range of approximately 20 mm to 45 mm, with a more specific sub-range of 24 mm to 27 mm (e.g., 25.425 mm), and in some cases extending to 24 mm to 50 mm when feed line distance variations are incorporated. These ranges are non-limiting and may be adjusted according to design objectives, such as bandwidth, impedance matching, and fabrication constraints. Additionally, variations in these parameters may be applied according to uniform or other statistical distributions to achieve decorrelated radiation characteristics across the antenna array 100.

The antenna positions 107 may be distributed across facets 102 such that the apertures 106 exhibit positional variation relative to the principal axis 115, for example, the nominal x-axis of the substrate coordinate system. In some embodiments, the apertures 106 may be offset along the y-axis, thereby introducing non-uniform spacing between adjacent Vivaldi antenna elements 105 and contributing to spatial incoherence in the radiated fields. The circular aperture termination 109 associated with each tapered slot 108 may likewise be positioned with variable displacement to maintain functional coupling while accommodating facet angle 103 variations. In certain examples, the physical components of the Vivaldi antenna element 105 may include tapered conductive wings defining the exponential tapered slot 108, a feed line 111 extending from a switching interface pad 114, and a radial stub 110 integrated at the feed line termination. In some implementations, all Vivaldi antenna elements 105 may share identical geometric parameters—such as taper rate, slot length, and stub dimensions—such that each element represents a translated copy of a baseline design. In other implementations, individual Vivaldi antenna elements 105 may exhibit variations in one or more parameters, including taper profile, aperture width, or feed line length 112, thereby introducing additional diversity in radiation characteristics. These variations may be applied according to a uniform random distribution or other statistical models to achieve desired incoherence properties across the antenna array 100.

In some embodiments, the feed lines 111 may be disposed either on the same or a different layer of the substrate 101 as the antenna elements 105 with any suitable routing configuration. As illustrated, the feedlines 111 are coplanar with antennas 105 but the technology can support any feedline physical arrangement, such as traveling through a via or like path through substrate 101. The feed lines 111 may be fabricated using printed conductive traces, for example, copper or other low-loss metallic materials deposited through additive manufacturing or subtractive etching processes. In further examples, the feed lines 111 may incorporate structural variations such as radial stubs 110, quarter-wave impedance matching sections, or other discontinuities configured to broaden operational bandwidth. The routing of the feed lines 111 may include curved segments, serpentine paths, or rectilinear sections, wherein the geometric configurations are selected to achieve prescribed electrical lengths while maintaining impedance continuity.

In additional embodiments, one or more feed line parameters may be varied to influence electromagnetic performance, including but not limited to feed line lengths 112 and feed line distances 113. The feed line distances 113 may correspond to the separations between the feed points and a constant x reference axis. In certain implementations, lengths 112 may reflect aperture displacements, such as in arrays where individual antenna elements 105 are translationally equivalent. In other examples, the slot lengths defining the apertures 106 may vary among elements, thereby producing differences in both aperture locations and feed line distances 113. Such variations may be applied independently or in combination with facet angle 103 randomization to achieve spatial and temporal incoherence. In some aspects, the feed line lengths 112 may be extended through meandered routing or additive segments to realize electrical lengths ΔLₘₙ selected from a uniform distribution over [0, 2π], thereby introducing randomized phase delays without altering the physical aperture geometries.

Further embodiments may incorporate any structural or dimensional modifications to the feed lines 111 that affect size, shape, length, or distance, including but not limited to variations in conductor widths, curvature radii, or termination geometries. For example, the feed lines 111 may include multiple bends positioned at irregular intervals, or may employ alternating straight and curved sections to achieve prescribed delay profiles. In other examples, the radial stubs 110 may exhibit different diameters or angular orientations relative to the feed line axes, and the circular aperture terminations 109 may be offset from the nominal centerlines of the tapered slots 108. These variations may be implemented according to deterministic or stochastic design rules, such as uniform random distributions or constrained optimization algorithms, to ensure that the resulting feed networks exhibit decorrelated phase characteristics across the antenna array 100. The combined effect of these physical variations—applied to feed line lengths 112, feed line distances 113, and associated structural features—contributes to the generation of electromagnetic fields that are uncorrelated in both spatial and temporal domains, thereby supporting interferometric imaging requirements without reliance on active phase control circuitry.

In some embodiments, the electromagnetic field distribution generated by the chaotic antenna array 100 may be characterized using a mathematical formulation that accounts for randomized element positions and feed line phase perturbations. For example, each radiating element indexed by (m,n) may exhibit a displacement vector r′ₘₙ defined as:

$${r}_{mn}^{′} = [ Δ {d}_{mn} cos {α}_{m n} ] \hat{x} + [ Δ {d}_{mn} sin {α}_{m n} ] \hat{y} ++ ( n - 1 ) d \hat{y} + ( m - 1 ) d \hat{z} .$$

where Δdₘₙ represents a random displacement magnitude selected from a uniform or constrained distribution, αₘₙ denotes an angular orientation of the displacement, and d corresponds to the nominal inter-element spacing along the respective axes. In further aspects, the feed line associated with each element may introduce an additional phase offset ΔLₘₙ, which is likewise randomized according to prescribed statistical rules.

Accordingly, the electric field radiated by element (m,n) toward an observation point at spherical coordinates (r, θ, φ) may be expressed as:

$${E}_{mn} = e ( θ , ϕ ) \frac{{e}^{- jkr}}{r} [ {e}^{jk ( n - 1 ) d sin θ sin ϕ} {e}^{jk ( m - 1 ) d cos θ} ] \times [ {e}^{jk Δ {d}_{mn} cos {α}_{mn} sin θ cos ϕ} {e}^{jk Δ {d}_{mn} sin {α}_{mn} sin θ sin ϕ} ] \times {e}^{- j Δ {L}_{mn}} \qquad ( 4 )$$

where k=2π/λ is the wavenumber, e_{θ,φ} denotes the modal electric field vector for an element at the origin, and the exponential terms collectively represent contributions from nominal array geometry and randomization-induced phase diversity. The first line of the equation corresponds to the case of conventional uniform array and second line stems from the randomizations introduced.
It is clearly seen that antenna position randomization generates additional phase (i.e. error with respect to conventional case) that is spatially varying whereas the feed line randomization generates a phase error that is equally transmitted to all directions.
The last three exponential factors introduce spatially varying and global phase errors that decorrelate the radiated fields across the aperture, thereby enforcing incoherence in both spatial and temporal domains. These mathematical relationships provide a basis for predicting and controlling the degree of incoherence achieved through structural variations in the antenna array 100.

In some embodiments, physical parameters of the chaotic antenna array (CAA), such as element positions, feed line lengths, and switching configurations, may be selected according to a predetermined incoherence metric. For example, the mutual coherence between two angular directions φₗ and φⱼ can be expressed as:

$${γ}_{ij} = \frac{\vert E ( {ϕ}_{i} , t ) {E}^{*} ( {ϕ}_{j} , t ) \vert}{‖ E ( {ϕ}_{i} , t ) ‖ ‖ {E}^{*} ( {ϕ}_{j} , t ) ‖}$$

where E(φᵢ,t) denotes the electric field at angular direction φᵢ and time t. Based on these coherence values, a gain function G(γᵢⱼ) may be defined to represent the effective directional gain associated with the antenna array configuration. Accordingly, the optimization may be formulated as:

$$minimize {\sum }_{i \neq j} {γ}_{ij} subject to G ( {γ}_{ij} ) \geq G$$

where G is a predetermined gain threshold ensuring that the aperture maintains sufficient power for long-range operation while suppressing off-diagonal coherence terms to achieve spatial incoherence.

In further embodiments, the constraint may alternatively be expressed in terms of an aggregate coherence metric, such as:

$${\sum }_{i , j} {γ}_{ij} \geq M$$

where M is a target parameter associated with overall gain performance or power distribution uniformity.

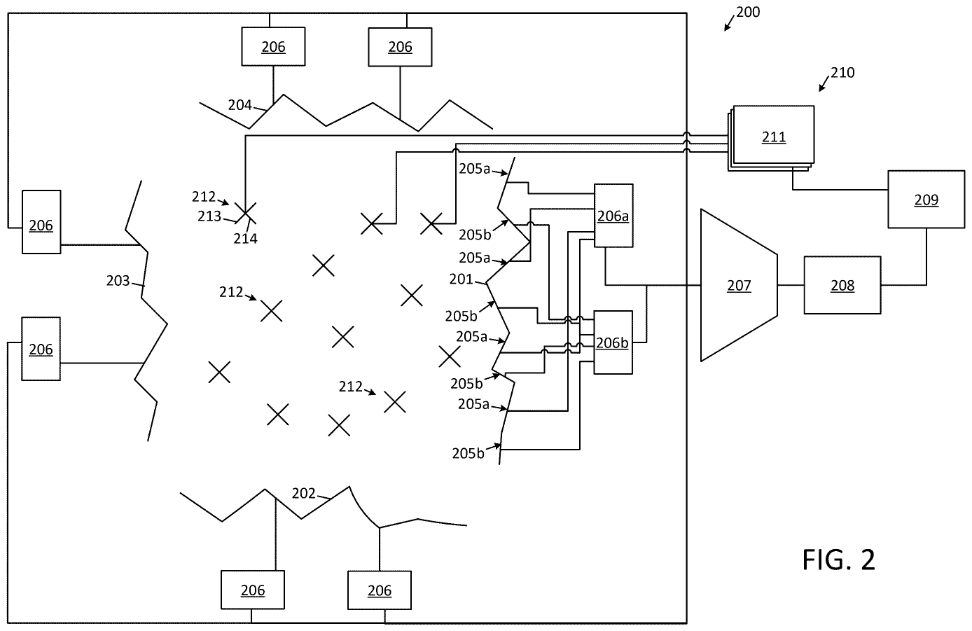

Referring now to FIG. 2, an imaging system 200 may comprise a plurality of transmission arrays 201-204, each of which may be implemented in accordance with the configurations described with respect to FIGS. 1A and 1B, or in any other suitable arrangement. The depiction of four transmission arrays and associated components in FIG. 2 is provided for explanatory purposes only and is not intended to limit the scope of possible implementations. In some embodiments, the imaging system 200 may include any number of transmission arrays, such as but not limited to two, four, eight, or more, wherein each array may comprise any suitable number of radiating elements, for example 8, 16, 32, 64, 128 elements or other quantities, and may be arranged in any orientation, such as along orthogonal axes, oblique angles, or other spatial configurations. Additionally, the arrays may be disposed in linear, planar, or volumetric arrangements, and may incorporate structural variations or geometric diversity to achieve desired operational characteristics. In further examples, the arrays may be configured to support different antenna types, such as Vivaldi antennas or other slot-based radiators suitable for millimeter-wave operation, and may be fabricated using additive manufacturing techniques or other suitable processes.

In some examples, imaging system 200 may include a controller 209 configured to manage operational aspects of transmission and reception subsystems. In some embodiments, the controller 209 may comprise one or more processing units implemented using any suitable technology, such as but not limited to general-purpose microprocessors, digital signal processors (DSPs), application-specific integrated circuits (ASICs), field-programmable gate arrays (FPGAs), programmable logic devices, or combinations thereof, etc. The controller 209 may further include associated circuitry for timing generation, signal routing, and interface management, and may be operatively coupled to memory resources comprising non-transitory computer-readable media storing executable instructions for implementing control sequences, multiplexing operations, waveform synthesis, and imaging algorithms, etc. In some aspects, the controller 209 may additionally include hardware accelerators, FPGAs, GPUs, co-processing modules, etc. to perform various imaging functions, such as correlation matrix computation, Fourier-domain transforms, or iterative reconstruction routines, etc. The controller 209 may also incorporate analog and mixed-signal circuitry for signal conditioning, calibration, and synchronization across multiple transmission arrays, as well as any other circuitry necessary to perform imaging operations as described herein.

In some embodiments, the controller 209 may generate or cause the generation of transmission signals supplied to a demultiplexer 207 and subsequently to one or more transmission arrays 201-204. The transmission signal may comprise a noise signal (e.g., a temporally incoherent signal). The noise signal may exhibit characteristics such as but not limited to pseudo-random sequences, random sequences, statistically noisy profiles, white noise, dark noise, additive white Gaussian noise (AWGN), or other suitable noise distributions, etc. In certain examples, the controller 209 may synthesize the composite waveform internally using digital-to-analog conversion stages, while in other examples, the controller 209 may issue control signals to an external noise source coupled to an analog front end 208. The analog front end 208 may perform signal conditioning operations such as amplification, filtering, and impedance matching prior to routing the waveform to the transmission arrays. The amplitude and spectral properties of the noise component may be scaled to maintain aggregate power constraints while maximizing entropy in the transmitted field, thereby reducing spatial and temporal correlation across the aperture.

The front-end circuitry for the millimeter-wave transmission system may include the analog front end 208, which in some embodiments comprises any suitable combination of components such as low-noise amplifiers (LNAs), power amplifiers (PAS), bandpass filters, impedance matching networks, biasing circuits, and thermal management structures, etc., configured for broadband operation in the millimeter-wave spectrum. Additional components may include phase-stable interconnects and switching elements integrated within the substrate to maintain operational stability under high-frequency conditions.

Referring further to FIG. 2, the excitation signal generated by controller 209 may be routed through demultiplexer 207, which operates as a distribution node for supplying the signal to a plurality of switches 206a, 206b, and additional switches within switch group 206. Each switch 206 may comprise multiple output ports, each port being operatively coupled to a corresponding radiating element within element sets 205a and 205b of transmission arrays 201-204. In some embodiments, the switches 206 may be implemented as high-frequency RF switches, such as PIN diode switches, MEMS-based switches, or other suitable technologies configured for millimeter-wave operation. The input port of each switch may be selectively connected to one or more output ports under control of a select signal communicated via a control interface, thereby enabling dynamic activation of different subsets of antenna elements.

In the illustrated example, eight switches are shown, and accordingly eight antenna elements are energized simultaneously during a given activation interval. However, this configuration is provided for explanatory purposes only and is not intended to limit the scope of possible implementations. In some embodiments, the number of switches, the number of ports per switch, and the grouping logic may vary substantially, for example from two switches per array to dozens of switches distributed across multiple arrays, depending on aperture size, power constraints, and imaging resolution objectives. Similarly, the number of transmission arrays may range from two to four, eight, or more, and each array may include any suitable number of radiating elements, such as but not limited to 8, 16, 32, 64, or other quantities.

In certain examples, the switching network may be configured to activate one element from element set 205a and one element from element set 205b within a given array at a time, as illustrated by switches 206a and 206b coupled to respective subsets of elements. In other embodiments, multiple elements from each set may be activated concurrently, or activation patterns may follow randomized or pseudo-random sequences to enforce temporal incoherence. For example, the controller 209 may implement stochastic algorithms that select element groups according to uniform, Gaussian, or Poisson distributions, or may employ deterministic constraints such as maintaining a minimum number of active elements per array to satisfy aggregate power requirements while varying group composition to reduce mutual coherence among radiating subsets. Additionally, the switching logic may support alternative activation schemes beyond simple random selection. In some aspects, activation sequences may be determined according to incoherence metrics, such as minimizing aggregate spatial correlation across the aperture, or may incorporate adaptive algorithms responsive to scene characteristics or imaging objectives.

The illustrated embodiment depicts four transmission arrays 201-204, with two arrays energized at any given time; however, other configurations may energize different numbers of arrays or elements concurrently. For instance, in some implementations, activation may occur in groups of four elements per array, eight elements across multiple arrays, or other non-limiting combinations. These variations may be applied independently or in combination with randomized timing sequences to maximize entropy in the transmitted field.

In some embodiments, imaging system 200 may include a receive subsystem comprising a plurality 211 of circuits 210, wherein each circuit 210 is operatively coupled to a corresponding receive antenna element 212. Each circuit 210 may include analog signal conditioning stages, such as but not limited to low-noise amplifiers (LNAs), bandpass filters, impedance matching networks, biasing circuits, and thermal management structures, etc., configured for broadband millimeter-wave operation. Additionally, each circuit 210 may incorporate digitization resources, such as high-speed analog-to-digital converters (ADCs) with sampling rates exceeding 1 GS/s and resolutions of 12 bits or greater, etc., enabling element-level data acquisition for interferometric processing.

Each receive antenna element 212 may comprise a first polarization antenna 213 and a second polarization antenna 214, wherein the first polarization antenna 213 may be configured to receive signals in a horizontal polarization state and the second polarization antenna 214 may be configured to receive signals in a vertical polarization state. In some embodiments, additional polarization configurations may be supported, such as ±45° slant polarizations, circular polarizations (left-hand or right-hand), or elliptical polarizations, etc., wherein the antenna structure may include multiple feed points or integrated switching elements to enable dynamic selection among polarization states. For example, a Vivaldi antenna structure may incorporate orthogonal slots and associated feed networks to support multiple polarization modes, while alternative designs may employ crossed dipoles, spiral antennas, or other broadband antennas suitable for polarization diversity.

In some aspects, the plurality of circuits 210 may include polarization selection circuitry operatively coupled to controller 209, enabling software-controlled switching between polarization channels. Such circuitry may comprise low-loss RF switches, such as PIN diode switches, MEMS-based switches, or solid-state devices, etc., configured for millimeter-wave operation with minimal insertion loss and high isolation. In further examples, the circuits 210 may include multi-channel digitizers capable of simultaneously sampling both polarization components, thereby eliminating the need for sequential switching and enabling concurrent acquisition of polarization-diverse data sets.

The controller 209 may implement control sequences for polarization switching according to predetermined patterns or stochastic algorithms, such as uniform random selection, Gaussian-distributed switching intervals, or adaptive schemes responsive to scene characteristics, etc. In some embodiments, the controller 209 may synchronize polarization switching with transmission array activation patterns to maximize entropy in the composite illumination and reception fields. Additionally, the controller 209 may execute calibration routines to align gain and phase across polarization channels, employing reference signals or internal calibration loops integrated within circuits 210.

In further examples, the receive subsystem may support acquisition of data across more than two polarization states to enhance target discrimination and imaging fidelity. For instance, the system may employ a set of polarization modes including horizontal, vertical, ±45° slant, and circular polarizations, etc., wherein the receive antenna elements 212 may incorporate multiple feed structures or reconfigurable substrates fabricated using additive manufacturing techniques. In some embodiments, circuits 210 may incorporate FPGA-based logic for preliminary data processing, such as decimation, filtering, and packetization, prior to transfer to controller 209 via high-speed interfaces, such as PCIe or Ethernet, etc.

In some embodiments, the receive subsystem may implement sparse array configurations, wherein the number of active receive elements at any given time is substantially less than the total available positions. Such sparsity may be achieved through positioning and number of receive elements 212, randomized or pseudo-random activation patterns coordinated by controller 209, which may select subsets of receive circuits 211 according to uniform, Gaussian, Poisson, or other statistical distributions, etc. Accordingly, sparse configurations may reduce cost, weight, and power consumption while preserving the ability to satisfy the Van Cittert-Zernike theorem for interferometric imaging. The number of arrays and elements may vary widely, for example two, four, eight, or more arrays, each comprising any suitable number of elements, such as but not limited to 8, 16, 32, or other quantities, depending on aperture size, power constraints, or imaging resolution objectives.

Referring further to FIG. 2, the controller 209 may perform imaging operations by processing digitized signals acquired from the plurality of receive circuits 211 associated with receive elements 212. In some embodiments, the controller 209 may implement interferometric processing based on the Van Cittert-Zernike theorem, wherein the spatial coherence function of the received field is related to the Fourier transform of the scene intensity distribution. Each receive circuit 210 may provide time-domain samples of the electric field components captured by corresponding polarization antennas 213 and 214, and these samples may be organized according to element position, polarization state, and activation interval.

In certain aspects, the controller 209 may compute pairwise cross-correlations among signals received at distinct element positions, such that the correlation function

$${Γ}_{p , q} = \int {E}_{p} ( t ) {E}_{q}^{*} ( t ) dt$$

represents a sample of the spatial frequency domain determined by the baseline vector between elements p and q. By accumulating correlation measurements across multiple randomized activation states of the transmit arrays 201-204 and receive elements 212, the controller 209 may populate a visibility function V(u,v) over a two-dimensional spatial frequency domain. The scene intensity I(α,β) may then be reconstructed through an inverse Fourier transform expressed as

$$I ( α , β ) = {\int }_{- ∞}^{∞} {\int }_{- ∞}^{∞} V ( u , v ) {e}^{- j 2 π ( u α + v β )} du dv ,$$

where (α,β) correspond to direction cosines relative to the imaging aperture.

In some embodiments, the controller 209 may extend this framework to one-dimensional (1D), two-dimensional (2D), and three-dimensional (3D) imaging modalities. For 1D imaging, correlation samples may be computed along a single cross-range axis, whereas 2D imaging may involve correlation synthesis across orthogonal axes using baselines formed by element pairs distributed over planar or faceted apertures. For 3D imaging, the controller 209 may incorporate range resolution by exploiting frequency diversity or pulsed timing sequences, wherein the fast-time dimension provides down-range sampling and the slow-time dimension indexes successive activation states. In further examples, the controller 209 may apply phase-compensation techniques to reconstruct volumetric reflectivity functions using a system response matrix derived from array geometry and activation patterns, expressed in simplified form as

$$\hat{ρ} = {H}^{†} s ,$$

where H denotes the system response matrix and s represents the measured signal vector.

In some cases, the controller 209 may exploit knowledge of activation patterns of switches 206, measured radiation patterns of transmission arrays 201-204, receive element positions, and polarization states. Additionally, statistical models of injected noise perturbations and switching sequences may be incorporated to refine incoherence metrics and suppress artifacts arising from residual correlations. In some embodiments, calibration data or simulated array responses may be used to estimate the composite electric field distribution across angular and frequency domains, enabling iterative algorithms that reconcile measured visibilities with predicted patterns. Accordingly, by leveraging randomized activation patterns, noise-injected illumination, dual-polarization reception, and interferometric correlation processing, the controller 209 may synthesize high-resolution images across one, two, or three spatial dimensions without reliance on conventional beamforming or phase-controlled architectures.

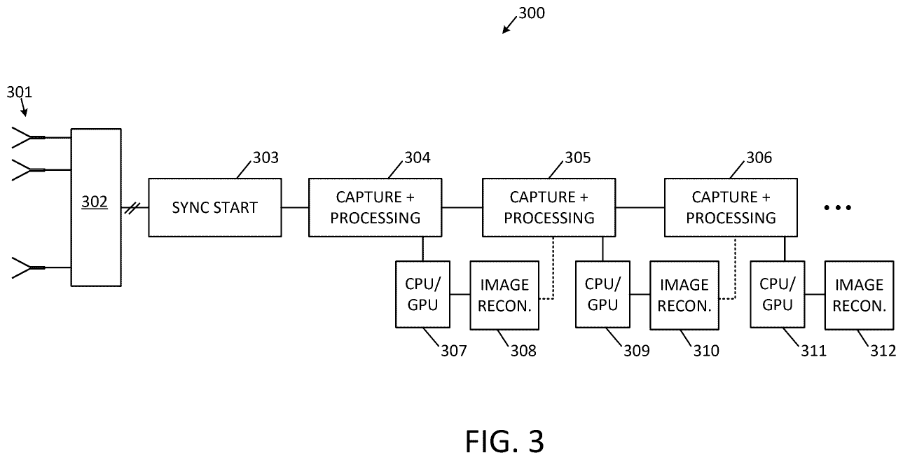

Referring now to FIG. 3, an image processing architecture 300 is illustrated, which broadly represents an exemplary configuration for implementing interferometric imaging operations. The depiction of architecture 300 is provided for explanatory purposes only and is not intended to limit the scope of possible implementations. In some embodiments, architecture 300 may be realized on any suitable computing platform, such as but not limited to a consumer-grade computer, a server-class machine, a dedicated imaging system, or a distributed computing environment comprising multiple nodes. The operational sequences described herein may be executed in parallel, in serial, or in any combination thereof, and may incorporate pipeline-based processing, concurrent execution of multiple algorithmic stages, or adaptive scheduling responsive to computational resource availability. Additionally, the architecture may support hierarchical or decentralized control schemes, wherein synchronization and initialization block 303 coordinates timing and resource allocation among capture blocks 304-306 and reconstruction blocks 308-312, while permitting alternative arrangements such as centralized orchestration or fully autonomous processing nodes.

In some embodiments, architecture 300 includes a receive antenna array 301 configured to capture reflected scene illumination at millimeter-wave frequencies from an incoherent transmission system, such as those described above with respect to FIG. 2. The receive antenna array 301 may comprise a plurality of antenna elements arranged in any suitable configuration, such as linear, planar, or volumetric layouts, and may incorporate structural diversity to enhance spatial sampling. In further aspects, the array may implement sparse configurations, wherein the number of active elements at any given time is substantially less than the total available positions, thereby reducing cost, weight, and power consumption while maintaining compliance with interferometric imaging requirements such as the Van Cittert-Zernike theorem. Sparsity may be achieved through randomized or pseudo-random activation patterns coordinated by controller logic, which may select subsets of elements according to uniform, Gaussian, Poisson, or other statistical distributions. Each antenna element may be configured to receive electromagnetic energy scattered from the scene under illumination by temporally and spatially incoherent waveforms, and may further support polarization diversity, wherein individual elements or element groups include feed structures for multiple polarization states, such as horizontal, vertical, ±45° slant, or circular polarizations, etc., enabling acquisition of polarization-resolved data sets for improved target discrimination.

Additionally, architecture 300 includes signal acquisition circuitry 302 operatively coupled to receive antenna array 301. In some aspects, circuitry 302 may comprise analog front-end components such as low-noise amplifiers, bandpass filters, and impedance matching networks configured for broadband millimeter-wave operation, as well as digitization resources such as high-speed analog-to-digital converters (ADCs) with sampling rates exceeding 1 GS/s and resolutions of 12 bits or greater. In further examples, circuitry 302 may incorporate polarization switching mechanisms enabling dynamic selection among multiple polarization states. Such mechanisms may include low-loss RF switches, such as PIN diode or MEMS-based devices, controlled by synchronization block 303 or by software sequences executed on controller logic within CPU/GPU blocks. In some embodiments, polarization switching may follow predetermined patterns or stochastic algorithms, such as uniform random selection or Gaussian-distributed intervals, and may be synchronized with capture block activation to maximize entropy in the composite data set. Alternatively, circuitry 302 may support simultaneous acquisition of multiple polarization channels using multi-channel digitizers, thereby eliminating sequential switching and enabling concurrent processing of polarization-diverse signals.

Referring further to FIG. 3, synchronization and initialization block 303 may comprise circuitry, firmware, software, or any combination thereof configured to generate a start signal that establishes a deterministic reference for acquisition cycles across capture blocks 304-306 and associated processing modules. In some embodiments, block 303 may distribute a timing signal through phase-stable interconnects to coordinate activation of signal acquisition circuitry 302 and subsequent data transfer operations. The synchronization function may be implemented using various technologies, such as but not limited to oscillators, phase shifters, programmable delay elements, or digital timing generators, and may include configuration registers or control logic for selecting operational modes such as single-shot acquisition, continuous streaming, or burst capture.

Architecture 300 may further comprise capture and processing blocks 304, 305, and 306. In some examples, the number of such blocks may correspond to the number of receive antenna elements included in antenna array 301. In some embodiments, each capture and processing block 304-306 is operatively associated with a respective antenna element or a group of antenna elements configured for different polarization states, such as horizontal, vertical, slant, circular, etc. Each block 304-306 may include circuitry operable to perform signal acquisition and conversion functions, wherein the block receives an analog millimeter-wave signal from its corresponding antenna element and converts the signal into an analog or digital representation suitable for subsequent processing.

In some aspects, each capture and processing block 304-306 may include analog front-end components such as low-noise amplifiers, bandpass filters, impedance matching networks, etc., configured for broadband millimeter-wave operation, as well as digitization resources such as analog-to-digital converters (ADCs) and optional digital-to-analog converters (DACs) for hybrid-domain operations. Additionally, each block 304-306 may include image processing circuitry comprising programmable logic devices such as field-programmable gate arrays (FPGAs), application-specific integrated circuits (ASICs), or specialized accelerators, including but not limited to dot-product accelerators, matrix multiplication engines, etc. These processing resources may implement interferometric correlation algorithms, Fourier-domain reconstruction techniques, or other computational kernels, and may execute operations in the analog domain, the digital domain, or a combination thereof. In further aspects, alternative configurations may be employed wherein capture and processing blocks 304-306 operate in parallel, in serial, in cascaded arrangements, etc.

Architecture 300 may further comprise comprises a plurality of computational modules, such as processor blocks 307, 309, and 311, and image reconstruction blocks 308, 310, and 312. These modules collectively perform reconstruction and further processing subsequent to initial signal acquisition and conversion by capture and processing blocks 304-306. In some embodiments, each processor block may include a central processing unit (CPU), a graphics processing unit (GPU), or a combination thereof, configured to receive processed outputs from a corresponding capture and processing block. For example, processor block 307 may be operatively coupled to block 304, processor block 309 to block 305, and processor block 311 to block 306. Optional interconnections between processor blocks may permit exchange of intermediate data for cooperative computation across multiple processing paths. Each processor block may execute numerical operations such as correlation, Fourier-domain inversion, and adaptive filtering, either independently or in conjunction with hardware accelerators such as field-programmable gate arrays (FPGAs) or application-specific integrated circuits (ASICs).

In some aspects, image reconstruction blocks 308, 310, and 312 may be implemented as executable instructions stored on a non-transitory computer-readable medium and executed by one or more of the processor blocks. These reconstruction blocks may perform interferometric synthesis, range migration, or compressive reconstruction, and may incorporate iterative algorithms such as total-variation minimization or gradient-based optimization. The reconstruction pipeline may operate in a staged configuration, wherein image reconstruction block 308 processes preliminary imagery derived from capture and processing block 304 and may forward intermediate results to processor block 305 for integration with its own dataset. In further examples, image reconstruction block 308 may generate partial Fourier-domain estimates or correlation matrices that processor block 305 combines with locally acquired measurements to improve spatial sampling and reduce coherence-related artifacts.

In some embodiments, processor block 307, image reconstruction block 308, and processor block 311 may be consolidated within a single processing unit executing multiple concurrent threads, thereby reducing component count while maintaining computational parallelism through software-level concurrency. Alternatively, these blocks may be distributed across separate processors operating in parallel, each assigned to a distinct subset of reconstruction tasks, such as polarization-resolved imaging, frequency diversity exploitation, or phase compensation. Selection between consolidated and distributed configurations may be based on system-level considerations including thermal management, power allocation, and throughput requirements.

The architecture may support multiple imaging modalities, including one-dimensional (1D), two-dimensional (2D), and three-dimensional (3D) reconstruction. In some implementations, 1D imaging may involve generation of a cross-range profile using a linear interferometric aperture. Two-dimensional imaging may synthesize planar reflectivity maps by combining cross-range and down-range dimensions through Fourier inversion. For three-dimensional imaging, additional processing steps may be employed to resolve volumetric structures, such as frequency diversity integration or time-domain gating to infer depth. Unique aspects of 3D imaging may include longitudinal coherence control and phase compensation across multiple switching states of the chaotic antenna array, as well as application of matched-filtering or range migration algorithms to reconstruct volumetric reflectivity functions. Conversely, 2D imaging may incorporate aperture randomization strategies to mitigate grating lobes and spatial aliasing, while 1D imaging may prioritize reduced computational complexity for high-frame-rate acquisition.

The outputs generated by architecture 300 may include amplitude-only reflectivity maps, phase-resolved interferometric images, polarization-sensitive composites, volumetric three-dimensional representations, etc. These outputs may be stored, formatted for display, archived for subsequent analysis, transmitted to external processing systems for automated classification or recognition, input into a neural network model such as a CNN-based model, etc.

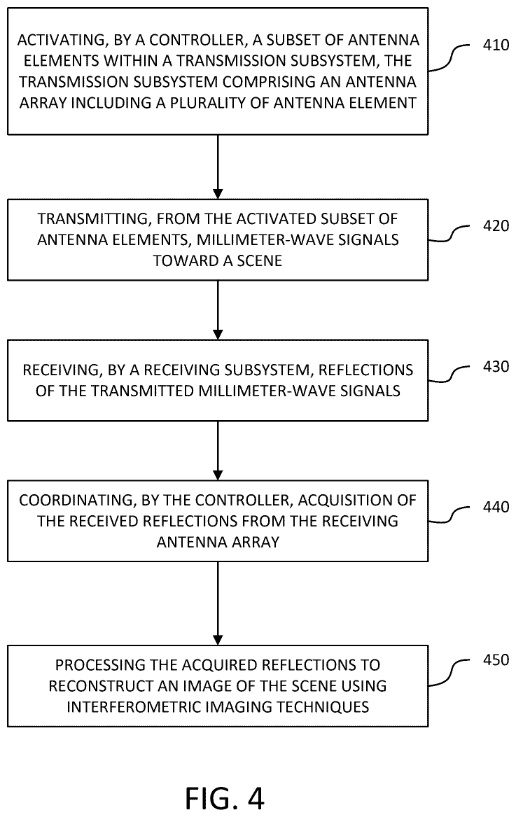

FIG. 4 illustrates a flowchart of an example method for interferometric imaging. At step 410, a controller activates a subset of antenna elements within a transmission subsystem, the transmission subsystem comprising an antenna array including a plurality of antenna elements, each antenna element comprising a planar slot antenna and an integrated feedline, wherein positions of antenna apertures of the plurality of antenna elements are uncorrelated, wherein orientation angles of the plurality of antenna elements are uncorrelated, and wherein lengths of the integrated feedlines of the plurality of antenna elements are uncorrelated. At step 420, the activated subset of antenna elements transmits millimeter-wave signals toward a scene. At step 430, a receiving subsystem receives reflections of the transmitted millimeter-wave signals, the receiving subsystem comprising a receiving antenna array including a plurality of receive antennas arranged in a sparse configuration, the receiving antenna array comprising dual-polarized antennas and polarization selection circuitry. At step 440, the controller coordinates acquisition of the received reflections from the receiving antenna array. At step 450, the acquired reflections are processed to reconstruct an image of the scene using interferometric imaging techniques.

FIG. 4 illustrates certain components that may be included within a control system 500, which may be configured to manage operations associated with embodiments of the present disclosure, such as the features discussed with reference to FIGS. 1-4. One or more control systems 500 may cooperate with external devices and subsystems to implement the various functions described herein.

The control system 500 includes one or more processors 504. The processor(s) 504 may comprise a single processor or multiple processors and/or sub-processors. The processor(s) 504 may include, for example, a general-purpose single- or multi-chip microprocessor (such as an Advanced RISC Machine (ARM)), a special-purpose microprocessor (such as a digital signal processor (DSP)), a microcontroller, a programmable gate array, and so forth. The processor(s) 504 may be referred to as a central processing unit (CPU). Although a single processor 504 is shown in FIG. 4, in alternative configurations, a combination of processors (such as an ARM and DSP) may be employed. In some embodiments, the control system 500 may further include one or more graphics processing units (GPUs) configured to provide processing services related to image rendering or computational acceleration.

The control system 500 also includes a medium 501 in electronic communication with the processor(s) 504. The medium 501 may be any non-transitory computer-readable medium capable of storing electronic information. For example, the medium 501 may include random access memory (RAM), read-only memory (ROM), magnetic disk storage media, optical storage media, flash memory devices, on-board memory integrated with the processor, erasable programmable read-only memory (EPROM), electrically erasable programmable read-only memory (EEPROM), registers, and combinations thereof. The medium 501 may include a single storage device or multiple storage devices.

Instructions 502 and data 503 may be stored in the medium 501. The instructions 502 may be executable by the processor(s) 504 to implement some or all of the functionality disclosed herein. Executing the instructions 502 may involve the use of the data 503 stored in the medium 501. Any of the various modules and components described herein may be implemented, partially or wholly, as instructions 502 stored in the medium 501 and executed by the processor(s) 504. Similarly, any of the various examples of data described herein may be among the data 503 stored in the medium 501 and used during execution of the instructions 502 by the processor(s) 504.

The control system 500 may also include one or more communication interfaces 505 for exchanging signals with other electronic devices. The communication interface(s) 505 may employ wired communication technology, wireless communication technology, or both. Examples of communication interfaces 505 include, without limitation, Universal Serial Bus (USB) ports, Ethernet adapters, wireless adapters operating in accordance with IEEE 802.11 protocols, Bluetooth® wireless communication adapters, and infrared (IR) communication ports.

The control system 500 may further include one or more input devices 506 and one or more output devices 507. Examples of input devices 506 include keyboards, mice, microphones, remote control devices, buttons, joysticks, trackballs, touchpads, and lightpens. Examples of output devices 507 include speakers and printers. A specific type of output device that is typically included in the control system 500 is a display device 508. Display devices 508 may utilize any suitable image projection technology, such as liquid crystal display (LCD), light-emitting diode (LED), gas plasma, electroluminescence, or similar technologies, and may be provided in any desired number.

In some embodiments, the control system 500 may further include millimeter-wave imaging circuitry 509 configured to perform signal generation, reception, and processing associated with electromagnetic waves in the millimeter-wave spectrum. The millimeter-wave imaging circuitry 509 may comprise one or more transceiver modules, antenna arrays, and associated control logic for implementing imaging operations, including beamforming, signal modulation, and data acquisition. The millimeter-wave imaging circuitry 509 may operate in cooperation with the processor(s) 504 and the medium 501 to execute imaging algorithms, store captured data, and provide processed outputs to the display device 508 or other output devices 507.

It should be noted that the methods described herein describe possible implementations. The operations and the steps may be rearranged, or otherwise modified and other implementations are possible. Further, aspects from two or more of the methods may be combined.

The various illustrative blocks and components described in connection with the disclosure herein may be implemented or performed using a general-purpose processor, a DSP, an ASIC, a Central Processing Unit (CPU), a graphics processing unit (GPU), a neural processing unit (NPU), a Field Programmable Gate Array (FPGA) or other PLD, a quantum processor, a discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, a combination of classical and quantum processors, or any other such configuration). Any functions or operations described herein as being capable of being performed by a processor may be performed by multiple processors that, individually or collectively, are capable of performing the described functions or operations.

The functions described herein may be implemented using hardware, software executed by one or more processors, firmware, or any combination thereof. If implemented using software executed by multiple processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, controllers, firmware, hardwiring, circuitry, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer, whether classical or quantum. By way of example, and not limitation, non-transitory computer-readable media may include random access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection may be properly termed a computer-readable medium. For example, the software may be transmitted from a website, server, or other remote source using a wired technology such as a coaxial cable, fiber optic cable, twisted pair, digital subscriber line (DSL), universal serial bus (USB), high-definition multimedia interface (HDMI), video graphics array (VGA), digital visual interface (DVI), thunderbolt cable, power cable, ribbon cable, integrated services digital network (ISDN), or wireless technologies such as wireless fidelity (Wi-Fi), Bluetooth, cellular network, near-field communication (NFC), Zigbee, long range (LoRa), infrared (IR), radio frequency identification (RFID), light fidelity (Li-Fi), satellite, ultra-wideband (UWB), millimeter wave (mmWave), and microwave. The wired and or wireless technologies are included in the definition of computer-readable medium. Disk and disc, as used herein, include a compact disk (CD), laser disc, optical disc, digital versatile disc (DVD), floppy disk, and Blu-ray disc. Disks or discs may reproduce data magnetically or optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “computing” may refer to any operations that may be performed by a computer (or a computing device), including (but not limited to): computation, data storage, data retrieval, communication, execution of an algorithm, and the like. Further, as used herein, a “computing device” may refer to any device in which a computing operation may be carried out. A computing device may be, for example (but not limited to): a compute component, a storage component, a network device, a telecommunications component, and the like.

As used herein, the term “computing resource” may refer to any program, application, document, asset, executable program file, desktop environment, computing environment, network environment, or other resource made available to, for example, a user of a computing device. A computing resource may be delivered to a computing device via, for example (but not limited to): conventional installation, a method of streaming, a virtual machine executing on a remote computing device, execution from a removable storage device connected to the computing device (e.g., a universal serial bus (USB) device), and the like.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. As used herein, outputting at least one signal may refer to any type of signal that may be output, including wireless communication signals, electrical signals, or any other type of signal that may be transferred by voltages, currents, electromagnetic waves, magnetic fields or particles, optical fields or particles, or any combination thereof. As used herein, “communication” may refer to data transferring or passing, or may refer to two or more components coordinating a job or task. As used herein, the term “data” is intended to be broad in scope. In this manner, that term “data” embraces, for example, (but not limited to): a data stream (or stream data), data chunks, data blocks, atomic data, objects of any type, files of any type (e.g., media files, spreadsheet files, database files, etc.), directories, sub-directories, volumes, and the like.

Although the disclosure may describe components and functions that may be implemented in a particular example with reference to a particular standard or protocol, the disclosure is not limited to the standard or protocol. Other standards or protocols supporting similar functionality are considered equivalents thereof.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Furthermore, “and/or” as used in a list of items indicates an inclusive list such that, for example, a list of at least one of A, B, and/or C means A or B or C or AB or AC or BC or ABC (i.e., A and B and C). Also, as used herein, the phrase “based on” shall not be construed as a reference to a closed set of conditions. For example, an example step that may be described as “based on condition A” may be based on both a condition A and a condition B. For example, as used herein, the phrase “based on” shall be construed in the same manner as the phrase “based at least in part on.”

As used herein, including in the claims, the article “a” before a noun may be open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” may refer to any or all of the one or more components. For example, referring to “the one or more components” subsequently in the claims may be understood to be equivalent to referring to “at least one of the one or more components.”

The terms “determine,” “determining,” “identify,” or “identifying” encompasses a variety of actions and, therefore, “determining” or “identifying” can include calculating, computing, processing, deriving, investigating, looking up (such as via looking up in a table, a database, or another data structure), receiving, ascertaining, and the like. Also, “determining” or “identifying” can include receiving (for example, receiving information), accessing (for example, accessing data stored in memory), retrieving, and the like. Also, “determining” or “identifying” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label may be used in the specification, the description may be applicable to any one of the similar components having the same first reference label irrespective of the second reference label or other subsequent reference label.

The description set forth herein, in connection with the appended figures, describes example configurations and does not represent all the examples that may be implemented or that are within the scope of the claims. The term “example” or “instance” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples. The features of the various examples described herein may be combined in any suitable manner. It is contemplated that one or more features from one example may be incorporated into another example unless explicitly stated otherwise. The combinations of features from different examples are within the scope of the disclosure.

Although terms such as “document,” “file,” “segment,” “block,” or “object” may be used by way of example, the present disclosure is not limited to any particular form of representing and storing data or other information. Rather, the present disclosure may be equally applicable to any object capable of representing information.

It will be appreciated by those skilled in the art that while the disclosure has been described above in connection with particular examples, the disclosure is not necessarily so limited, and that numerous other examples, uses, means for, modifications and departures from the examples, uses, and means for are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A device comprising:
an antenna array comprising a plurality of antenna elements, each antenna element comprising a planar slot antenna and an integrated feedline;
wherein positions of antenna apertures of the plurality of antenna elements are uncorrelated;
wherein orientation angles of the plurality of antenna elements are uncorrelated; and
wherein lengths of the integrated feedlines of the plurality of antenna elements are uncorrelated.

2. The device of claim 1, further comprising a plurality of antenna arrays, each antenna array comprising a plurality of antenna elements, wherein at least two of the antenna arrays have different principal axes relative to a common reference axis.

3. The device of claim 1, wherein the antenna array comprises a row of antenna elements wherein neighboring antenna elements are angled relative to one another in a statistically random manner.

4. The device of claim 3, further comprising a substrate comprising an array of irregular ridges, wherein each planar slot antenna is disposed on a different face of the irregular ridges.

5. The device of claim 1, wherein the plurality of antenna elements comprise Vivaldi antennas.

6. The device of claim 1, further comprising a receiving antenna array comprising a plurality of receive antennas arranged in a sparse array, the receiving antenna array comprising dual-polarized antennas and polarization selection circuitry.

7. The device of claim 1, further comprising a switching circuit coupled to the antenna array to selectively activate subsets of the plurality of antenna elements.

8. The device of claim 7, further comprising a controller coupled to the switching circuit to implement randomized or pseudo-random activation of the subsets of antenna elements.

9. The device of claim 1, further comprising:
a signal generator coupled to the antenna array to produce a noise signal; and
an image processing system to generate a three-dimensional image of a scene by correlating signals received from a receiving antenna array with the noise-like transmission signal.

10. A system comprising:
a transmission subsystem comprising an antenna array including a plurality of antenna elements, each antenna element comprising a planar slot antenna and an integrated feedline;
wherein positions of antenna apertures of the plurality of antenna elements are uncorrelated;
wherein orientation angles of the plurality of antenna elements are uncorrelated;
wherein lengths of the integrated feedlines of the plurality of antenna elements are uncorrelated;
a receiving subsystem comprising a receiving antenna array including a plurality of receive antennas arranged in a sparse configuration, the receiving antenna array comprising dual-polarized antennas and polarization selection circuitry; and
a control subsystem operatively coupled to the transmission subsystem and the receiving subsystem, the control subsystem comprising a controller configured to activate of subsets of the plurality of antenna elements and to coordinate acquisition of signals from the receiving antenna array for interferometric imaging.

11. A method for interferometric imaging comprising:
activating, by a controller, a subset of antenna elements within a transmission subsystem, the transmission subsystem comprising an antenna array including a plurality of antenna elements, each antenna element comprising a planar slot antenna and an integrated feedline;
wherein positions of antenna apertures of the plurality of antenna elements are uncorrelated;
wherein orientation angles of the plurality of antenna elements are uncorrelated;
wherein lengths of the integrated feedlines of the plurality of antenna elements are uncorrelated;
transmitting, from the activated subset of antenna elements, millimeter-wave signals toward a scene;
receiving, by a receiving subsystem, reflections of the transmitted millimeter-wave signals;
coordinating, by the controller, acquisition of the received reflections from the receiving antenna array; and
processing the acquired reflections to reconstruct an image of the scene using interferometric imaging techniques.
